(19) United States
(12) Patent Application Publication
(10) Pub. No.: US 2018/0009696 A1
(43) Pub. Date: Jan. 11, 2018

(54) 3D PRINTER PRINTHEAD, 3D PRINTER USING SAME, METHOD FOR MANUFACTURING MOLDED PRODUCT BY USING 3D PRINTER, METHOD FOR MANUFACTURING ARTIFICIAL TOOTH BY USING 3D PRINTER, AND METHOD FOR MANUFACTURING MACHINABLE GLASS CERAMIC MOLDED PRODUCT BY USING 3D PRINTER

(71) Applicant: KOREA INSTITUTE OF CERAMIC ENGINEERING AND TECHNOLOGY, Gyeongsangnam-do (KR)

(72) Inventor: Hyeong Jun Kim, Gyeonggi-do (KR)

(73) Assignee: KOREA INSTITUTE OF CERAMIC ENGINEERING AND TECHNOLOGY, Gyeongsangnam-do (KR)

(21) Appl. No.: 15/543,037

(22) PCT Filed: Apr. 3, 2015
(86) PCT No.: PCT/KR2015/003339

§ 371 Date: Jul. 12, 2017

(30) Foreign Application Priority Data
Jan. 12, 2015 (KR) 10-2015-0003968
Jan. 29, 2015 (KR) 10-2015-0013914
Jan. 29, 2015 (KR) 10-2015-0013918

(51) Int. Cl. C03B 19/00; C03C 10/00; A61C 13/00; C03C 3/085; A61C 13/08; C03C 3/083; C03C 4/00

(52) U.S. Cl. CPC C03B 19/00; C03C 3/083; B33Y 30/00; C03C 10/0045; C03C 10/0027; C03C 4/0021; C03C 3/085; A61C 13/081; A61C 13/0019; B33Y 70/00; B33Y 10/00; C03C 2204/00

(57) ABSTRACT

The present invention relates to a 3D printer printhead, a 3D printer using the same, a method for manufacturing a molded product by using the 3D printer, a method for manufacturing an artificial tooth by using the 3D printer, and a method for manufacturing a machinable glass ceramic molded product by using the 3D printer, the 3D printer printhead comprising: an inlet through which glass wire, which is a raw material, is introduced; a heating means for heating the glass wire introduced through the inlet; a melting furnace for providing a space in which the glass wire is fused; and a nozzle connected to the lower part of the melting furnace so as to temporarily store the fused glass or discharge a targeted amount of the fused glass, wherein the melting furnace includes an exterior frame made from a heat resistant material and an interior frame having a crucible shape, and the interior frame is made from platinum (Pt), a Pt alloy or graphite, which have a low contact angle, or a material having a surface coated with Pt or a diamond-like carbon (DLC) so as to prevent the fused glass from sticking thereto. According to the present invention, the molded product, the artificial tooth, and the machinable glass ceramic molded product can be manufactured with excellent mechanical properties, thermal durability, chemical durability and oxidation resistance and outstanding texture by using the glass wire as a raw material.

### FIELD OF THE INVENTION

The present invention relates to a 3D printer printhead, a 3D printer using the same, a method for manufacturing a molded product using the 3D printer, a method for manufacturing an artificial tooth using the 3D printer, and a method for manufacturing a machinable glass ceramic molded product using the 3D printer, and more particularly, to a 3D printer printhead in which a wire made of glass as well as a thermoplastic resin may be used as a raw material, a 3D printer capable of manufacturing a molded product, which has excellent thermal durability, chemical durability and oxidation resistance and superior texture, using a glass wire as a raw material, a method for manufacturing a molded product using the 3D printer, a method for manufacturing an artificial tooth using the 3D printer, and a method for manufacturing a machinable glass ceramic molded product using the 3D printer.

### DISCUSSION OF RELATED ART

In recent years, there has been much research conducted on 3D printers capable of molding desired articles using three-dimensional (3D) data. Since the 3D printers may be used to easily mold and manufacture articles having a complicated structure based on the planned design, the market for 3D printers is expected to grow very large in the future.

Conventional 3D printers use a method which includes melting a wire made of a thermoplastic resin in a printhead, discharging the molten wire into a two-dimensional (2D) plane shape and stacking the molten thermoplastic resin on the 2D plane shape through the printhead to mold the thermoplastic resin into a desired 3D shape. The wire made of the thermoplastic resin is supplied to the printhead by means of a transfer roll, and the like, and the printhead is designed to be installed at a moving means whose position is adjusted in three directions of X, Y and Z axes to be movable with respect to the moving means.

However, in the case of the conventional 3D printers, finally molded articles must be plastic products because the thermoplastic resin is used as a raw material. Therefore, the thermoplastic resin is used restrictively because the thermoplastic resin has applications limited to only articles that can be made of plastics.

### PRIOR-ART DOCUMENTS

### Patent Documents

Korean Patent Publication No. 10-2009-0014395

Registered Korean Patent No. 10-1346704

### DISCLOSURE

### Technical Problem

Therefore, it is an aspect of the present invention to provide a 3D printer printhead in which a wire made of glass as well as a thermoplastic resin may be used as a raw material.

It is another aspect of the present invention to provide a 3D printer capable of manufacturing a molded product using a glass wire as a raw material. In this case, the molded product has excellent thermal durability, chemical durability and oxidation resistance and superior texture.

It is still another aspect of the present invention to provide a method for manufacturing a molded product using the 3D printer.

It is yet another aspect of the present invention to provide a method for manufacturing an artificial tooth using the 3D printer.

It is yet another aspect of the present invention to provide a method for manufacturing a machinable glass ceramic molded product using the 3D printer.

### TECHNICAL SOLUTION

According to one aspect of the present invention, there is provided a 3D printer printhead. Here, 3D printer printhead includes an inlet thorough which a glass wire, which is a raw material, is introduced; a heating means configured to heat the glass wire introduced through the inlet; a melting furnace configured to provide a space in which the glass wire is melted; and a nozzle coupled to a lower part of the melting furnace to temporarily store the molten glass or discharge a desired amount of the molten glass, wherein the melting furnace includes an outer frame made of a heat-resistant material and an inner frame having a crucible shape, and the inner frame is made of platinum (Pt), a Pt alloy or graphite, which has a low contact angle, or made of a material having a surface coated with Pt or diamond-like carbon (DLC) so as to prevent the molten glass from sticking thereto.

According to another aspect of the present invention, there is provided a 3D printer. Here, the 3D printer includes a raw material supply unit configured to supply a glass wire which is a raw material; a transfer unit configured to transfer the glass wire supplied from the raw material supply unit; a printhead configured to melt the glass wire transferred by the transfer unit and discharge the molten glass through a nozzle; a workbench configured to provide a space in which the molten glass discharged through the nozzle of the printhead is molded into a desired shape while being sequentially stacked; and a control unit configured to independently control operations of the transfer unit and the printhead, wherein the printhead is disposed above the workbench, and a molded product having a desired shape is three-dimensionally manufactured by adjusting a position of the printhead.

According to still another aspect of the present invention, there is provided a method for manufacturing a molded product using the 3D printer. Here, the method for manufacturing a molded product using the 3D printer includes installing a glass wire, which is a raw material, in a raw material supply unit; supplying the glass wire from the raw material supply unit to a printhead using a transfer unit; melting the glass wire supplied into the printhead and discharging the molten glass through a nozzle; molding the molten glass discharged through the nozzle of the printhead while sequentially stacking the molten glass in a workbench disposed below the printhead; and subjecting the molded product to heat treatment, wherein operations of the transfer unit and the printhead are independently controlled by a control unit, the molding is performed so that the molten glass is manufactured into 3D molded products by adjusting a position of the printhead, the glass wire is made of Li₂O—Al₂O₃—SiO₃-based glass or Li₂O—MgO—Al₂O₃—SiO₃-based glass, the Li₂O—Al₂O₃—SiO₃-based glass is glass including 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂, and the Li₂O—MgO—Al₂O₃—SiO₃-based glass is glass including 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

According to yet another aspect of the present invention, there is provided a method for manufacturing an artificial tooth using the 3D printer. Here, the method for manufacturing an artificial tooth using the 3D printer includes installing a glass wire, which is a raw material, in a raw material supply unit; supplying the glass wire from the raw material supply unit to a printhead using a transfer unit; melting the glass wire supplied into the printhead and discharging the molten glass through a nozzle; molding the molten glass discharged through the nozzle of the printhead while sequentially stacking the molten glass in a workbench disposed below the printhead; and subjecting the molded product to heat treatment, wherein operations of the transfer unit and the printhead are independently controlled by a control unit, the molding is performed so that the molten glass is manufactured into 3D molded products for artificial teeth by adjusting a position of the printhead, and the glass wire is made of lithium disilicate-based glass including 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO.

According to yet another aspect of the present invention, there is provided a method for manufacturing a machinable glass ceramic molded product using the 3D printer. Here, the method for manufacturing a machinable glass ceramic molded product using the 3D printer includes installing a glass wire, which is a raw material, in a raw material supply unit; supplying the glass wire from the raw material supply unit to a printhead using a transfer unit; melting the glass wire supplied into the printhead and discharging the molten glass through a nozzle; molding the molten glass discharged through the nozzle of the printhead while sequentially stacking the molten glass in a workbench disposed below the printhead; and subjecting the molded product to heat treatment, wherein operations of the transfer unit and the printhead are independently controlled by a control unit, the molding is performed so that the molten glass is manufactured into 3D molded products by adjusting a position of the printhead, and the glass wire is made of glass including 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F).

### Advantageous Effects

According to the 3D printer printhead of the present invention, a wire made of glass as well as a thermoplastic resin can be used as a raw material. Since a glass material can be used as the raw material, thermal durability, chemical durability, oxidation resistance and the like of a molded body can be improved, compared to when a thermoplastic resin is used as the raw material. When the wire made of glass is used as the raw material, the glass wire has an advantage in that the molded body has superior texture, compared to when the thermoplastic resin is used as the raw material.

According to the 3D printer printhead of the present invention, the glass wire can be made of glass having a chromatic color as well as achromatic transparent glass, and molded bodies having various desired colors can be manufactured by molding the molten glass with different colors.

According to the 3D printer of the present invention, a wire made of glass can be used as the raw material. Since a glass material can be used as the raw material, thermal durability, chemical durability, oxidation resistance and the like of a molded body can be improved, compared to when a thermoplastic resin is used as the raw material. When the wire made of glass is used as the raw material, the glass wire has an advantage in that the molded body has superior texture, compared to when the thermoplastic resin is used as the raw material.

The glass wire can be made of glass having a chromatic color as well as achromatic transparent glass, and molded bodies having various desired colors can be manufactured by molding the molten glass with different colors.

Also, the 3D printer of the present invention has advantages in that raw materials having different colors can be supplied to printheads by different transfer units, respectively, so that the raw materials can be continuously molded with different colors at desired positions under the control of the control units and molded bodies having various desired colors can be manufactured.

When the 3D printer of the present invention is used, molded products having excellent mechanical properties, thermal durability, chemical durability and oxidation resistance and superior texture can be manufactured.

When the 3D printer of the present invention is used, artificial teeth having excellent mechanical properties, thermal durability, chemical durability and oxidation resistance and superior texture can be manufactured.

When the 3D printer of the present invention is used, machinable glass ceramic molded products having excellent mechanical properties, thermal durability, chemical durability and oxidation resistance and superior texture can be manufactured.

The machinable glass ceramic molded products can be manufactured by determining the size and shape of the molded products according to an original equipment manufacturing method. The machinable glass ceramic molded products manufactured according to the present invention have an advantage in that the molded products can be machine-shaped according to customer demand.

### DESCRIPTION OF DRAWINGS

FIG. 1 is a diagram schematically showing a configuration of a 3D printer.

FIG. 2 is a diagram showing a 3D printer printhead according to one preferred embodiment of the present invention.

FIG. 3 is a diagram showing a 3D printer printhead according to another preferred embodiment of the present invention.

### BRIEF DESCRIPTION OF PARTS IN THE DRAWINGS

| | |
|---|---|
| 10: raw material supply unit | 20: transfer unit |
| 30: workbench | 40: control unit |
| 50: tube | 100: printhead |
| 110: inlet | 120a, 120b: heating means |
| 130: melting furnace | 140: nozzle |

### BEST MODE

A 3D printer printhead according to one preferred embodiment of the present invention includes an inlet thorough which a glass wire, which is a raw material, is introduced, a heating means configured to heat the glass wire introduced through the inlet, a melting furnace configured to provide a space in which the glass wire is melted, and a nozzle coupled to a lower part of the melting furnace to temporarily store the molten glass or discharge a desired amount of the molten glass. In this case, the melting furnace includes an outer frame made of a heat-resistant material and an inner frame having a crucible shape, and the inner frame is made of platinum (Pt), a Pt alloy or graphite, which has a low contact angle, or made of a material having a surface coated with Pt or diamond-like carbon (DLC) so as to prevent the molten glass from sticking thereto.

The nozzle may include an outer frame made of a heat-resistant material and an inner frame having a funnel shape, and the inner frame may be made of platinum (Pt), a Pt alloy or graphite, which has a low contact angle, or made of a material having a surface coated with Pt or diamond-like carbon (DLC) so as to prevent the molten glass from sticking thereto.

The outer frames of the melting furnace and the nozzle may be made of ceramic material for heat insulation, for example, a refractory material, a ceramic fiber board, or a ceramic blanket.

The molten glass discharged through the nozzle preferably has a viscosity ranging from 10² to 10¹⁰ poises.

The heating means may include a first heating means provided at a circumference of the melting furnace to melt glass wire inside the melting furnace, and a second heating means provided at a circumference of the nozzle to regulate the temperature and viscosity of the molten glass to be discharged.

A tube configured to guide an influx of the glass wire may be coupled to the inlet.

The glass wire may be made of a glass material having a chromatic color.

The 3D printer according to one preferred embodiment of the present invention includes a raw material supply unit configured to supply a glass wire which is a raw material, a transfer unit configured to transfer the glass wire supplied from the raw material supply unit, a printhead configured to melt the glass wire transferred by the transfer unit and discharge the molten glass through a nozzle, a workbench configured to provide a space in which the molten glass discharged through the nozzle of the printhead is molded into a desired shape while being sequentially stacked, and a control unit configured to independently control operations of the transfer unit and the printhead. In this case, the printhead is disposed above the workbench, and a molded product having a desired shape is three-dimensionally manufactured by adjusting a position of the printhead.

A plurality of raw material supply units may be provided, the transfer unit may include a plurality of transfer rolls, a plurality of printheads may be provided, depending on the number of pairs of transfer rolls and the number of raw material supply units, the plurality of printheads may form one group so that positions of the printheads can be adjusted, and the plurality of printheads may be set so that at least one printhead to be operated under the control of the control unit is selected and the molten glass is discharged through a nozzle of the selected printhead.

The glass wire may be made of Li₂O—Al₂O₃—SiO₃-based glass or Li₂O—MgO—Al₂O₃—SiO₃-based glass, the Li₂O—Al₂O₃—SiO₃-based glass may be glass including 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂, and the Li₂O—MgO—Al₂O₃—SiO₃-based glass may be glass including 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The Li₂O—Al₂O₃—SiO₃-based glass or the Li₂O—MgO—Al₂O₃—SiO₃-based glass may further include 0.005 to 0.5% by weight of CoO, and the glass wire may be a glass wire having a blue color.

The Li₂O—Al₂O₃—SiO₃-based glass or the Li₂O—MgO—Al₂O₃—SiO₃-based glass may further include 0.005 to 1.0% by weight of Cr₂O₃, and the glass wire may be a glass wire having a green color.

The Li₂O—Al₂O₃—SiO₃-based glass or the Li₂O—MgO—Al₂O₃—SiO₃-based glass may further include 0.05 to 1.0% by weight of MnO₂, and the glass wire may be a glass wire having a purple color.

The glass wire may be made of lithium disilicate-based glass including 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO.

The glass wire may be made of glass including 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F). The glass wire may further include 5.0 to 10.0% by weight of ZrO₂. The glass wire may further include 0.005 to 0.5% by weight of CoO, and the glass wire may be a glass wire having a blue color. The glass wire may further include 0.005 to 1.0% by weight of Cr₂O₃, and the glass wire may be a glass wire having a green color. The glass wire may further include 0.05 to 1.0% by weight of MnO₂, and the glass wire may be a glass wire having a purple color.

A method for manufacturing a molded product according to one preferred embodiment of the present invention is a method for manufacturing a molded product using the 3D printer, which includes installing a glass wire, which is a raw material, in a raw material supply unit, supplying the glass wire from the raw material supply unit to a printhead using a transfer unit, melting the glass wire supplied into the printhead and discharging the molten glass through a nozzle, molding the molten glass discharged through the nozzle of the printhead while sequentially stacking the molten glass in a workbench disposed below the printhead, and subjecting the molded product to heat treatment. In this case, operations of the transfer unit and the printhead are independently controlled by a control unit, the molding is performed so that the molten glass is manufactured into 3D molded products by adjusting a position of the printhead, the glass wire is made of Li₂O—Al₂O₃—SiO₃-based glass or Li₂O—MgO—Al₂O₃—SiO₃-based glass, the Li₂O—Al₂O₃—SiO₃-based glass is glass including 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂, and the Li₂O—MgO—Al₂O₃—SiO₃-based glass is glass including 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The heat treatment may include first heat treatment performed at a temperature of 650 to 800° C. for the purpose of nucleation for crystallization, and second heat treatment performed at a temperature of 900 to 1,100° C. for the purpose of crystallization.

A plurality of raw material supply units may be provided, the transfer unit may include a plurality of transfer rolls, a plurality of printheads may be provided, depending on the number of pairs of transfer rolls and the number of raw material supply units, the plurality of printheads may form one group so that positions of the printheads can be adjusted, and the plurality of printheads may be set so that at least one printhead to be operated under the control of the control unit is selected and the molten glass is discharged through a nozzle of the selected printhead.

A method for manufacturing an artificial tooth according to one preferred embodiment of the present invention is a method for manufacturing an artificial tooth using the 3D printer, which includes installing a glass wire, which is a raw material, in a raw material supply unit, supplying the glass wire from the raw material supply unit to a printhead using a transfer unit, melting the glass wire supplied into the printhead and discharging the molten glass through a nozzle, molding the molten glass discharged through the nozzle of the printhead while sequentially stacking the molten glass in a workbench disposed below the printhead; and subjecting the molded product to heat treatment. In this case, operations of the transfer unit and the printhead are independently controlled by a control unit, the molding is performed so that the molten glass is manufactured into 3D molded products for artificial teeth by adjusting a position of the printhead, and the glass wire is made of lithium disilicate-based glass including 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO.

The heat treatment may include first heat treatment performed at a temperature of 460 to 540° C. for the purpose of nucleation for crystallization, and second heat treatment performed at a temperature of 850 to 930° C. for the purpose of crystallization.

A plurality of raw material supply units may be provided, the transfer unit may include a plurality of transfer rolls, a plurality of printheads may be provided, depending on the number of pairs of transfer rolls and the number of raw material supply units, the plurality of printheads may form one group so that positions of the printheads can be adjusted, and the plurality of printheads may be set so that at least one printhead to be operated under the control of the control unit is selected and the molten glass is discharged through a nozzle of the selected printhead.

A method for manufacturing a machinable glass ceramic molded product according to one preferred embodiment of the present invention is a method for manufacturing a machinable glass ceramic molded product using the 3D printer, which includes installing a glass wire, which is a raw material, in a raw material supply unit, supplying the glass wire from the raw material supply unit to a printhead using a transfer unit, melting the glass wire supplied into the printhead and discharging the molten glass through a nozzle, molding the molten glass discharged through the nozzle of the printhead while sequentially stacking the molten glass in a workbench disposed below the printhead, and subjecting the molded product to heat treatment. In this case, operations of the transfer unit and the printhead are independently controlled by a control unit, the molding is performed so that the molten glass is manufactured into 3D molded products by adjusting a position of the printhead, and the glass wire is made of glass including 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F).

The heat treatment may include first heat treatment performed at a temperature of 500 to 750° C. for the purpose of nucleation for crystallization, and second heat treatment performed at a temperature of 900 to 1,100° C. for the purpose of crystallization.

A plurality of raw material supply units may be provided, the transfer unit may include a plurality of transfer rolls, a plurality of printheads may be provided, depending on the number of pairs of transfer rolls and the number of raw material supply units, the plurality of printheads may form one group so that positions of the printheads can be adjusted, and the plurality of printheads may be set so that at least one printhead to be operated under the control of the control unit is selected and the molten glass is discharged through a nozzle of the selected printhead.

### MODE FOR INVENTION

Hereinafter, preferred embodiments of the present invention will be described in detail with reference to the accompanying drawings. However, it will be apparent to persons having ordinary skill in the art that the following preferred embodiments are disclosed herein to fully understand the present invention, and thus various changes and modifications may be made to the preferred embodiments of the present invention without departing from the scope of the present invention. In the drawings, like numbers refer to like elements throughout the description of the figures.

Hereinafter, an X-axis direction and a Y-axis direction are perpendicular to each other, as viewed in one plane, and a Z-axis direction is used to represent a direction perpendicular to the one plane, that is, a direction perpendicular to the X-axis direction and the Y-axis direction.

The 3D printer printhead according to one preferred embodiment of the present invention includes an inlet thorough which a glass wire, which is a raw material, is introduced, a heating means configured to heat the glass wire introduced through the inlet, a melting furnace configured to provide a space in which the glass wire is melted, and a nozzle coupled to a lower part of the melting furnace to temporarily store the molten glass or discharge a desired amount of the molten glass. The melting furnace includes an outer frame made of a heat-resistant material and an inner frame having a crucible shape, and the inner frame is made of platinum (Pt), a Pt alloy or graphite, which has a low contact angle, or made of a material having a surface coated with Pt or diamond-like carbon (DLC) so as to prevent the molten glass from sticking thereto.

The 3D printer according to one preferred embodiment of the present invention includes a raw material supply unit configured to supply a glass wire which is a raw material, a transfer unit configured to transfer the glass wire supplied from the raw material supply unit, a printhead configured to melt the glass wire transferred by the transfer unit and discharge the molten glass through a nozzle, a workbench configured to provide a space in which the molten glass discharged through the nozzle of the printhead is molded into a desired shape while being sequentially stacked, and a control unit configured to independently control operations of the transfer unit and the printhead. In this case, the printhead is disposed above the workbench, and a molded product having a desired shape is three-dimensionally manufactured by adjusting a position of the printhead.

The method for manufacturing a molded product according to one preferred embodiment of the present invention is a method for manufacturing a molded product using the 3D printer, which includes installing a glass wire, which is a raw material, in a raw material supply unit, supplying the glass wire from the raw material supply unit to a printhead using a transfer unit, melting the glass wire supplied into the printhead and discharging the molten glass through a nozzle, molding the molten glass discharged through the nozzle of the printhead while sequentially stacking the molten glass in a workbench disposed below the printhead, and subjecting the molded product to heat treatment. In this case, operations of the transfer unit and the printhead are independently controlled by a control unit, the molding is performed so that the molten glass is manufactured into 3D molded products by adjusting a position of the printhead, the glass wire is made of Li₂O—Al₂O₃—SiO₃-based glass or Li₂O—MgO—Al₂O₃—SiO₃-based glass, the Li₂O—Al₂O₃—SiO₃-based glass is glass including 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂, and the Li₂O—MgO—Al₂O₃—SiO₃-based glass is glass including 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The method for manufacturing an artificial tooth according to one preferred embodiment of the present invention is a method for manufacturing an artificial tooth using the 3D printer, which includes installing a glass wire, which is a raw material, in a raw material supply unit, supplying the glass wire from the raw material supply unit to a printhead using a transfer unit, melting the glass wire supplied into the printhead and discharging the molten glass through a nozzle, molding the molten glass discharged through the nozzle of the printhead while sequentially stacking the molten glass in a workbench disposed below the printhead, and subjecting the molded product to heat treatment. In this case, operations of the transfer unit and the printhead are independently controlled by a control unit, the molding is performed so that the molten glass is manufactured into 3D molded products for artificial teeth by adjusting a position of the printhead, and the glass wire is made of lithium disilicate-based glass including 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO.

The method for manufacturing a machinable glass ceramic molded product according to one preferred embodiment of the present invention is a method for manufacturing a machinable glass ceramic molded product using the 3D printer, which includes installing a glass wire, which is a raw material, in a raw material supply unit, supplying the glass wire from the raw material supply unit to a printhead using a transfer unit, melting the glass wire supplied into the printhead and discharging the molten glass through a nozzle, molding the molten glass discharged through the nozzle of the printhead while sequentially stacking the molten glass in a workbench disposed below the printhead, and subjecting the molded product to heat treatment. In this case, operations of the transfer unit and the printhead are independently controlled by a control unit, the molding is performed so that the molten glass is manufactured into 3D molded products by adjusting a position of the printhead, and the glass wire is made of glass including 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F).

Hereinafter, the 3D printer printhead according to one preferred embodiment of the present invention, the 3D printer using the same, the method for manufacturing a molded product using the 3D printer, the method for manufacturing an artificial tooth using the 3D printer, and the method for manufacturing a machinable glass ceramic molded product using the 3D printer will be described in further detail.

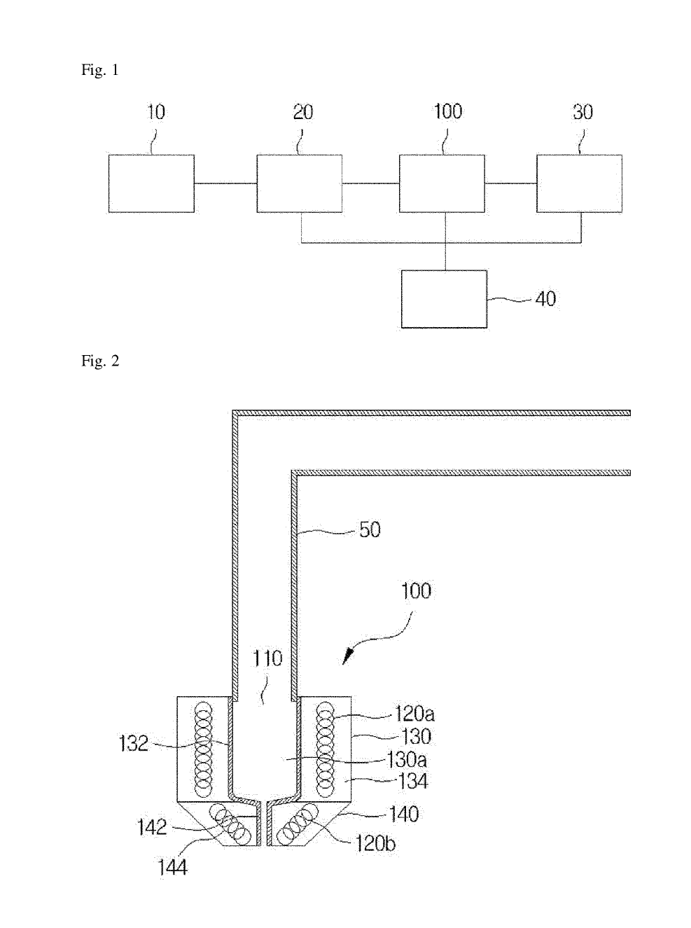

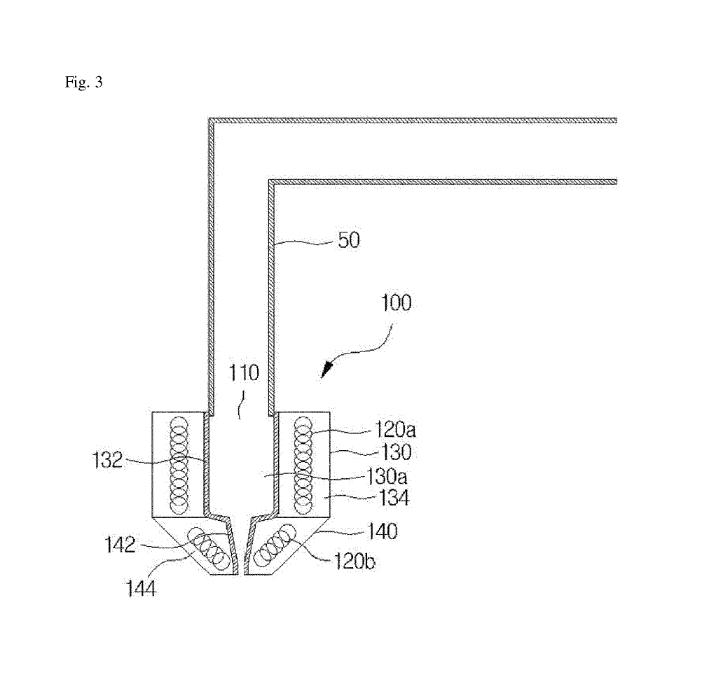

FIG. 1 is a diagram schematically showing a configuration of a 3D printer, FIG. 2 is a diagram showing a 3D printer printhead according to one preferred embodiment of the present invention, and FIG. 3 is a diagram showing a 3D printer printhead according to another preferred embodiment of the present invention.

Referring to FIGS. 1 to 3, the 3D printer includes a raw material supply unit 10 includes a raw material supply unit 10 configured to supply a raw material such as a wire made of glass (i.e., a glass wire), a transfer unit 20 configured to transfer the raw material supplied from the raw material supply unit 10, a printhead 100 configured to melt the raw material transferred by the transfer unit 20 and discharge the molten glass through a nozzle 140, a workbench 30 configured to provide a space in which the molten glass discharged through the nozzle 140 of the printhead 100 is molded into a desired shape while being sequentially stacked, and a control unit 40 configured to independently control operations of the transfer unit 20 and the printhead 100.

The raw material includes a wire made of glass (i.e., glass wire). Glass wire made of soda lime-based glass, borosilicate-based glass, aluminosilicate-based glass, phosphate-based glass, and the like may be used as the glass wire. Specific examples of the glass may, for example, include zinc oxide (ZnO)-boric oxide (B₂O₃)-silicon oxide (SiO₂)-based glass, zinc oxide (ZnO)-boric oxide (B₂O₃)-silicon oxide (SiO₂)-aluminum oxide (Al₂O₃)-based glass, zinc oxide (ZnO)-boric oxide (B₂O₃)-silicon oxide (SiO₂)-aluminum oxide (Al₂O₃)-phosphoric acid (P₂O₅)-based glass, lead oxide (PbO)-boric oxide (B₂O₃)-silicon oxide (SiO₂)-based glass, lead oxide (PbO)-boric oxide (B₂O₃)-silicon oxide (SiO₂)-aluminum oxide (Al₂O₃)-based glass, lead oxide (PbO)-zinc oxide (ZnO)-boric oxide (B₂O₃)-silicon oxide (SiO₂)-based glass, lead oxide (PbO)-zinc oxide (ZnO)-boric oxide (B₂O₃)-silicon oxide (SiO₂)-aluminum oxide (Al₂O₃)-based glass, bismuth oxide (Bi₂O₃)-boric oxide (B₂O₃)-silicon oxide (SiO₂)-based glass, bismuth oxide (Bi₂O₃)-boric oxide (B₂O₃)-silicon oxide (SiO₂)-aluminum oxide (Al₂O₃)-based glass, bismuth oxide (Bi₂O₃)-zinc oxide (ZnO)-boric oxide (B₂O₃)-silicon oxide (SiO₂)-aluminum oxide (Al₂O₃)-based glass, etc. The glass wire may be made of an achromatic transparent glass material, and may also be made of a glass material having a chromatic color. Since a glass material may be used as the raw material, thermal durability, chemical durability, oxidation resistance and the like of a molded body may be improved, compared to when a thermoplastic resin is used as the raw material. When the glass wire is used as the raw material, the glass wire has an advantage in that the molded body has superior texture, compared to when the thermoplastic resin is used as the raw material.

Also, the glass wire may be made of Li₂O—Al₂O₃—SiO₃-based glass or Li₂O—MgO—Al₂O₃—SiO₃-based glass. The glass wire may be made of an achromatic transparent glass material, and may also be made of a glass material having a chromatic color.

The Li₂O—Al₂O₃—SiO₃-based glass may be glass including 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The Li₂O serves to lower a glass transition temperature (T_{g}) and enhance a melting property. However, when the content of such a Li₂O component is too high, stability of the glass wire may be lowered, and mechanical strength of the glass wire may be degraded.

The Al₂O₃ serves to improve resistance to devitrification and chemical durability of glass. When the content of Al₂O₃ is too high, vitrification becomes difficult, and the glass transition temperature (T_{g}) may rise.

The SiO₂ is an oxide that forms glass, and an essential component used to form the backbone of glass. Also, the SiO₂ is a component which promotes regulation of the viscosity of glass by adjusting the SiO₂ content and is effective in improving resistance to devitrification of glass. When the content of SiO₂ is too low, the resistance to devitrification may be deteriorated, and the index of refraction may be reduced. When the SiO₂ content is too high, the glass transition temperature (T_{g}) or viscosity of glass is likely to increase.

The ZnO serves as a fluxing agent or a chemical stabilizer.

The SnO₂ serves as a refining or crystallization aid.

The TiO₂ or ZrO₂ is used as a crystallization aid, and thus serves to promote nucleation.

The Li₂O—Al₂O₃—SiO₃-based glass may further include 0.005 to 0.5% by weight of CoO, and the glass wire may be a glass wire having a blue color. The CoO serves as a coloring agent that develops a blue color.

Also, the Li₂O—Al₂O₃—SiO₃-based glass may further include 0.005 to 1.0% by weight of Cr₂O₃, and the glass wire may be a glass wire having a green color. The Cr₂O₃ serves as a coloring agent that develops a green color.

In addition, the Li₂O—Al₂O₃—SiO₃-based glass may further include 0.05 to 1.0% by weight of MnO₂, and the glass wire may be a glass wire having a purple color. The MnO₂ serves as a coloring agent that develops a purple color.

The Li₂O—MgO—Al₂O₃—SiO₃-based glass may be glass including 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The Li₂O—MgO—Al₂O₃—SiO₃-based glass may further include 0.005 to 0.5% by weight of CoO, and the glass wire may be a glass wire having a blue color. The CoO serves as a coloring agent that develops a blue color.

Also, the Li₂O—MgO—Al₂O₃—SiO₃-based glass may further include 0.005 to 1.0% by weight of Cr₂O₃, and the glass wire may be a glass wire having a green color. The Cr₂O₃ serves as a coloring agent that develops a green color.

In addition, the Li₂O—MgO—Al₂O₃—SiO₃-based glass may further include 0.05 to 1.0% by weight of MnO₂, and the glass wire may be a glass wire having a purple color. The MnO₂ serves as a coloring agent that develops a purple color.

Further, the glass wire may be made of lithium disilicate-based glass including 25.0 to 30.0 mol % Li₂O, 60.0 to 70.0 mol % SiO₂, 0.5 to 1.5 mol % P₂O₅, 1.0 to 6.0 mol % K₂O and 1.0 to 4.0 mol % ZnO. The glass wire may be made of an achromatic transparent glass material, and may also be made of a glass material having a chromatic color.

The Li₂O serves to lower a glass transition temperature (T_{g}) and enhance a melting property. However, when the content of such a Li₂O component is too high, stability of the glass wire may be lowered, and mechanical strength of the glass wire may be degraded.

The SiO₂ is an oxide that forms glass, and an essential component used to form the backbone of glass. Also, the SiO₂ is a component that promotes regulation of the viscosity of glass by adjusting the SiO₂ content and is effective in improving resistance to devitrification of glass. When the SiO₂ content is too low, the resistance to devitrification may be deteriorated, and the index of refraction may be reduced. When the SiO₂ content is too high, the glass transition temperature (T_{g}) or viscosity of glass is likely to increase.

K₂O serves to lower a glass transition temperature and enhance a melting property. However, when the K₂O content is too high, the resistance to devitrification and chemical durability may be degraded.

The ZnO serves as a fluxing agent or a chemical stabilizer.

Also, the glass wire may be made of glass including 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F). The glass wire may be made of an achromatic transparent glass material, and may also be made of a glass material having a chromatic color.

The Al₂O₃ serves to improve resistance to devitrification and chemical durability of glass. When the content of Al₂O₃ is too high, vitrification becomes difficult, and the glass transition temperature (T_{g}) may rise.

The SiO₂ is an oxide that forms glass, and an essential component used to form the backbone of glass. Also, the SiO₂ is a component which promotes regulation of the viscosity of glass by adjusting the SiO₂ content and is effective in improving resistance to devitrification of glass. When the content of SiO₂ is too low, the resistance to devitrification may be deteriorated, and the index of refraction may be reduced. When the SiO₂ content is too high, the glass transition temperature (T_{g}) or viscosity of glass is likely to increase.

K₂O serves to lower a glass transition temperature and enhance a melting property. However, when the K₂O content is too high, the resistance to devitrification and chemical durability may be degraded.

The glass wire may further include 5.0 to 10.0% by weight of ZrO₂. The ZrO₂ may be used as a crystallization aid, and thus may serve to promote nucleation.

The glass wire may further include 0.005 to 0.5% by weight of CoO, and the glass wire may be a glass wire having a blue color. The CoO serves as a coloring agent that develops a blue color.

Also, the glass wire may further include 0.005 to 1.0% by weight of Cr₂O₃, and the glass wire may be a glass wire having a green color. The Cr₂O₃ serves as a coloring agent that develops a green color.

In addition, the glass wire may further include 0.05 to 1.0% by weight of MnO₂, and the glass wire may be a glass wire having a purple color. The MnO₂ serves as a coloring agent that develops a purple color.

It is apparent that a wire (or a filament) made of a thermoplastic resin may also be used in addition to the glass wire. Examples of the thermoplastic resin may include a polylactic acid (PLA) resin, a polyphenylene sulfide (PPS) resin, a polyvinyl chloride (PVC) resin, an acrylonitrile butadiene styrene (ABS) resin, etc.

Since the glass material may be used as the raw material of the 3D printer, thermal durability, chemical durability, oxidation resistance and the like of the molded body may be improved, compared to when the thermoplastic resin is used as the raw material. When the glass wire is used as the raw material, the glass wire has an advantage in that the molded body has superior texture, compared to when the thermoplastic resin is used as the raw material.

The raw material supply unit 10 serves to supply a raw material such as a glass wire. In this case, a plurality of raw material supply units may be provided. The raw material supply unit 10 may be provided in the form of a reel around which a raw material such as a glass wire may be wound. In this case, a plurality of reels around which the raw material may be wound to supply the raw material to the transfer unit 20 may be provided.

The transfer unit 20 serves to transfer the raw material supplied from the raw material supply unit 10 to the printhead 100. The transfer unit 20 may be provided with at least a pair of transfer rolls, and the raw material may be supplied to the printhead 100 using the transfer rolls. The wire-shaped raw material is transferred forward in a state in which the raw material is engaged between a pair of transfer rolls. A plurality of pairs of transfer rolls may be provided. When a plurality of pairs of transfer rolls are provided, each of the pair of transfer rolls may be independently driven.

The workbench 30 provides a space in which the molten raw material (molten glass, etc.) discharged through the nozzle of the printhead 100 is molded into a desired shape while being sequentially stacked. The workbench 30 may be provided to move up and down (ascend or descend) in a Z-axis direction by means of a moving means, and may also be provided to horizontally move back and forth in a plane in X-axis and Y-axis directions.

The printhead 100 serves to melt the raw material transferred by the transfer unit 20 and discharge the molten glass through a nozzle 140, which makes it possible to manufacture a molded product having a desired shape. The printhead 100 may be coupled to a moving means (not shown), and a position of the printhead 100 may be adjusted by the moving means. The printhead 100 may be provided to horizontally move back and forth in a plane in X-axis and Y-axis directions by means of the moving means, or may be provided to move up and down (ascend or descend) in a Z-axis direction. For example, when the workbench 30 is provided to move up and down in the Z-axis direction, the printhead 100 is provided to horizontally move back and forth in a plane in the X-axis and Y-axis directions. On the other hand, when the workbench 30 is provided to horizontally move back and forth in a plane in the X-axis and Y-axis directions, the printhead 100 is provided to move up and down in the Z-axis direction. When the workbench 30 is fixed, the printhead 100 is provided to move back and forth in the X-axis, Y-axis and Z-axis directions by means of the moving means. The printhead 100 is disposed above the workbench 30, and a molded product having a desired shape is three-dimensionally manufactured by adjusting a position of the printhead 100.

The moving means configured to adjust a position of the workbench 30 or the printhead 100 may have various shapes and modes. Examples of the modes may, for example, include a mode in which the printhead 100 moves back and forth along a guide in an X-axis direction, a mode in which the printhead 100 moves back and forth along a guide in a Y-axis direction, and a mode in which the printhead 100 moves back and forth along a guide in a Z-axis direction.

The control unit 40 serves to independently control operations of the transfer unit 20 and the printhead 100. The control unit 40 may control the operation of the transfer unit 20 to adjust a transfer rate of the raw material, etc. Also, the control unit 40 may adjust a position of the printhead 100, etc. In addition, the control unit 40 may serve to control a position of the workbench 30 when the workbench 30 is provided to move up and down in a Z-axis direction or provided to horizontally move in a plane in X-axis and Y-axis directions. The control unit 40 controls the moving means to adjust a position of the printhead 100 or the workbench 30, depending on the 3D data of an object to be molded.

The printhead 100 includes an inlet 110 thorough which a raw material is introduced, heating means 120a and 120b configured to heat the raw material introduced through the inlet 110, a melting furnace 130 configured to provide a space in which the raw material is melted, and a nozzle 140 coupled to a lower part of the melting furnace 130 to temporarily store the raw material (molten glass when the glass wire is used as the raw material) or discharge a desired amount of the raw material. In this case, a plurality of printheads 100 may be provided, depending on the number of pairs of transfer rolls in the transfer unit 20 and the number of raw material supply units 10, etc. When the plurality of printheads 100 are provided, the plurality of printheads 100 form one group so that positions of the printheads 100 are adjusted. As described above, when the plurality of printheads 100 are provided, the plurality of printheads 100 may be set so that at least one printhead 100 to be operated under the control of the control unit 40 is selected and the raw material is discharged through a nozzle 140 of the selected printhead 100.

The glass wire may also be directly coupled to the inlet 110 of the printhead. However, as shown in FIGS. 2 and 3, a tube 50 configured to guide an influx of the raw material may be coupled to the inlet 110. More specifically, a tube 50 configured to guide a transfer path of the raw material may be provided between the inlet 110 of the printhead 100 and the transfer unit 20. The raw material such as a glass wire may be transferred to the inlet 110 of the printhead 100 along the inside of the tube 50 as the transfer unit 20 is driven.

The content, influx rate, and the like of the raw material introduced through the inlet 110 of the printhead 100 may be adjusted by controlling the transfer unit 20 under the control of the control unit 40. When a plurality of pairs of transfer rolls are provided in the transfer unit 20 and a plurality of printheads 100 are provided to correspond to the plurality of pairs of transfer rolls, the raw material introduced through the inlet 110 of the printhead 100 may be selectively supplied by selectively controlling the transfer unit 20 under the control of the control unit 40. When raw materials having different colors are supplied to the printheads 100 through the different transfer units 20, respectively, the raw materials can be continuously molded with different colors at desired positions under the control of the control units 40. The molded products having various desired colors, such as a molded product for artificial teeth, a machinable glass ceramic molded product, etc., may be manufactured by molding the raw materials with different colors.

The heating means 120a of the printhead 100 is disposed at a circumference of the melting furnace 130, and serves to heat and melt the raw material introduced through the inlet 110. The heating temperature of the heating means 120a may be properly chosen and set in consideration of physical properties of the raw material, characteristics of the molded body, etc. The raw material is heated to a proper temperature to be melted in the melting furnace 130. The plurality of heating means 120a and 120b may be provided. For example, the first heating means 120a may be provided at a circumference of the melting furnace 130 to melt the raw material in the inside 130a of the melting furnace, and the second heating means 120b may be provided at a circumference of the nozzle 140 to adjust the temperature and viscosity of the molten glass to be discharged.

When the glass wire is used as the raw material, the temperature of the inside 130a of the melting furnace heated by the heating means is preferably a temperature higher than a dilatometric softening point (T_{dsp}) of the glass wire that is a raw material, that is, a temperature at which the glass wire is sufficiently melted. The dilatometric softening point (T_{dsp}) of glass has an intrinsic value, depending on the type of glass, components, etc. The temperature of the inside 130a of the melting furnace is properly regulated according to the type of the raw material to be melted, and the heating means 120a has a characteristic of controlling the temperature according to the characteristics of the raw material.

The raw material is introduced into the melting furnace 130 through the inlet 110. In this case, the melting furnace 130 serves to provide a space in which the raw material is melted by heating with the heating means 120a, and the inside 130a of the melting furnace may be formed in a crucible shape. The melting furnace 130 may include an outer frame 134 made of a heat-resistant material and an inner frame 132 having a crucible shape formed in the outer frame 134. The inner frame 132 of the melting furnace 130 may have a high surface strength and may cope with a melting temperature of the glass wire. In this case, the inner frame 132 is preferably made of a material having a low contact angle so as to prevent the molten glass from sticking thereto. For this purpose, the inner frame 132 is preferably made of a material such as platinum (Pt), a Pt alloy, graphite, etc., or may be made of a material having a surface coated with a material such as Pt or diamond-like carbon (DLC). For example, a metal such as iron (Fe), titanium (Ti) or an alloy thereof, or a superhard material, such as tungsten carbide (WC), which has a surface coated with a material such as platinum (Pt) or diamond like carbon (DLC), may be used for the inner frame 132. The outer frame 134 of the melting furnace 130 serves to insulate the heat so as to maximally prevent the loss of heat, and thus is preferably made of a material having a thermal barrier effect, for example, a refractory material, a ceramic material such as a ceramic fiber board, a ceramic blanket, etc. It is desirable to form a bottom surface of the melting furnace 130 in an oblique type in terms of the smooth flow through the nozzle 140. The molten glass discharged through the nozzle 140 has a viscosity higher than the viscosity corresponding to the dilatometric softening point (T_{dsp}) of glass, that is, a viscosity ranging from 10² to 10¹⁰ poises.

The raw material melted in the melting furnace 130 is introduced into the nozzle 140. The nozzle 140 is coupled to a lower part of the melting furnace 130, and thus serves to temporarily store or discharge the molten glass. The nozzle 140 of the printhead 100 is a unit configured to discharge the molten raw material into a desired location in the workbench 30. As shown in FIG. 2, the nozzle 140 may be provided so that the nozzle 140 has the same diameter in a direction in which the raw material is discharged. As shown in FIG. 3, the nozzle 140 may also be provided so that the nozzle 140 may be formed in a funnel shape or has a diameter tapering in a direction in which the raw material is discharged. The diameter of the nozzle 140 may be properly chosen and determined in consideration of physical properties of the raw material, characteristics of the molded body, etc. The nozzle 140 may include an outer frame 144 made of a heat-resistant material and an inner frame 142 having a funnel shape formed in the outer frame 144. The inner frame 142 of the nozzle 140 may have a high surface strength and may cope with a melting temperature of the glass wire. In this case, the inner frame 142 is preferably made of a material having a low contact angle so as to prevent the molten glass from sticking thereto. For this purpose, the inner frame 142 is preferably made of a material such as platinum (Pt), a Pt alloy, graphite, etc., or may be made of a material having a surface coated with a material such as Pt or diamond-like carbon (DLC). For example, a metal such as iron (Fe), titanium (Ti) or an alloy thereof, or a superhard material, such as tungsten carbide (WC), which has a surface coated with a material such as platinum (Pt) or diamond like carbon (DLC), may be used for the inner frame 142. The outer frame 144 of the nozzle 140 serves to insulate the heat so as to maximally prevent the loss of heat, and thus is preferably made of a material having a thermal barrier effect, for example, a refractory material, a ceramic material such as a ceramic fiber board, a ceramic blanket, etc. The melting furnace 130 and the nozzle 140 are separated, but may also be integrally formed.

The molded products having a desired shape, such as a molded product for artificial teeth, a machinable glass ceramic molded product, etc., are three-dimensionally manufactured by spraying the molten raw material through the nozzle 140.

Hereinafter, the method for manufacturing a molded product using the 3D printer according to one preferred embodiment of the present invention will be described in further detail.

A glass wire that is a raw material is installed in the raw material supply unit 10. The glass wire is made of Li₂O—Al₂O₃—SiO₃-based glass or Li₂O—MgO—Al₂O₃—SiO₃-based glass. The glass wire may be made of an achromatic transparent glass material, and may also be made of a glass material having a chromatic color.

The Li₂O—Al₂O₃—SiO₃-based glass may be glass including 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The Li₂O—Al₂O₃—SiO₃-based glass may further include 0.005 to 0.5% by weight of CoO, and the glass wire may be a glass wire having a blue color. The CoO serves as a coloring agent that develops a blue color.

Also, the Li₂O—Al₂O₃—SiO₃-based glass may further include 0.005 to 1.0% by weight of Cr₂O₃, and the glass wire may be a glass wire having a green color. The Cr₂O₃ serves as a coloring agent that develops a green color.

In addition, the Li₂O—Al₂O₃—SiO₃-based glass may further include 0.05 to 1.0% by weight of MnO₂, and the glass wire may be a glass wire having a purple color. The MnO₂ serves as a coloring agent that develops a purple color.

The Li₂O—MgO—Al₂O₃—SiO₃-based glass may be glass including 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

The Li₂O—MgO—Al₂O₃—SiO₃-based glass may further include 0.005 to 0.5% by weight of CoO, and the glass wire may be a glass wire having a blue color. The CoO serves as a coloring agent that develops a blue color.

Also, the Li₂O—MgO—Al₂O₃—SiO₃-based glass may further include 0.005 to 1.0% by weight of Cr₂O₃, and the glass wire may be a glass wire having a green color. The Cr₂O₃ serves as a coloring agent that develops a green color.

In addition, the Li₂O—MgO—Al₂O₃—SiO₃-based glass may further include 0.05 to 1.0% by weight of MnO₂, and the glass wire may be a glass wire having a purple color. The MnO₂ serves as a coloring agent that develops a purple color.

The glass wire is supplied from the raw material supply unit 10 to the printhead 100 using the transfer unit 20.

The glass wire supplied into the printhead 100 is melted, and the molten glass is discharged through the nozzle 140. The discharge temperature of the molten glass discharged through the nozzle 140 is preferably in a range of approximately 1,000 to 1,600° C. The molten glass discharged through the nozzle 140 preferably has a viscosity ranging from 10² to 10¹⁰ poises.

A plurality of raw material supply units 10 may be provided, the transfer unit 20 may include a plurality of transfer rolls, a plurality of printheads 100 are provided, depending on the number of pairs of transfer rolls and the number of raw material supply units 10, the plurality of printheads 100 may form one group so that positions of the printheads can be adjusted, and the plurality of printheads 100 may be set so that at least one printhead 100 to be operated under the control of the control unit 40 is selected and the molten glass is discharged through a nozzle 140 of the selected printhead 100.

The molten glass discharged through the nozzle 140 of the printhead 100 is molded while being sequentially stacked in the workbench 30 disposed below the printhead 100. Operations of the transfer unit 20 and the printhead 100 are independently controlled by the control unit 40. The molding is performed so that the molten glass is manufactured into 3D molded products by adjusting a position of the printhead 100.

The molded product (i.e., a molded body) manufactured in a 3D shape through the nozzle 140 may be subjected to heat treatment. The molded product may be crystallized using a heat treatment process. The heat treatment may include first heat treatment for nucleation prior to crystallization, and second heat treatment for crystallization.

Hereinafter, the heat treatment process will be described.

The molded product is heated to increase the temperature of the molded product to a first temperature (for example, 650 to 800° C.), and the first temperature is maintained for a predetermined time (for example, 10 minutes to 12 hours) to form nuclei for crystallization (a first heat treatment process). The TiO₂ or ZrO₂ component contained in the glass wire is used as a crystallization aid, and thus serves to promote nucleation. The first heat treatment process is preferably performed in an oxidizing atmosphere such as oxygen (O₂), air, etc.

The molded product is heated to increase the temperature of the molded product to a second temperature (for example, 900 to 1,100° C.), which is higher than the first temperature, and the second temperature is maintained for a predetermined time (for example, 10 minutes to 24 hours) to crystallize the molded product (a second heat treatment process). The second heat treatment process is preferably performed in an oxidizing atmosphere such as oxygen (O₂), air, etc.

A cooling process of slowly cooling the heat-treated product is performed. The reasons for slow cooling are to remove residual stress and to secure a stable position of an atomic structure during the cooling process.

The resulting crystals may differ depending on the compositional components of the glass wire used and contents thereof, heat treatment, etc. In this case, crystal phases such as beta-quartz, spodumene (LiAlSi₂O₆), and cordierite are formed.

The molded product thus manufactured has a dilatometric softening point of 800 to 1,000° C. and a thermal expansion coefficient of 0.1×10⁻⁶/° C. to 3×10⁻⁶/° C.

When the 3D printer according to one preferred embodiment of the present invention is used, molded products having excellent thermal durability, chemical durability and oxidation resistance and superior texture may be manufactured.

Hereinafter, the method for manufacturing an artificial tooth using the 3D printer according to one preferred embodiment of the present invention will be described in further detail.

The glass wire that is a raw material is installed in the raw material supply unit 10. The glass wire may be made of lithium disilicate-based glass including 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO. The glass wire may be made of an achromatic transparent glass material, and may also be made of a glass material having a chromatic color.

The glass wire is supplied from the raw material supply unit 10 to the printhead 100 using the transfer unit 20.

The glass wire supplied into the printhead 100 is melted, and the molten glass is discharged through the nozzle 140. The discharge temperature of the molten glass discharged through the nozzle 140 is preferably in a range of approximately 1,000 to 1,600° C. The molten glass discharged through the nozzle 140 preferably has a viscosity ranging from 10² to 10¹⁰ poises.

A plurality of raw material supply units 10 may be provided, the transfer unit 20 may include a plurality of transfer rolls, a plurality of printheads 100 are provided, depending on the number of pairs of transfer rolls and the number of raw material supply units 10, the plurality of printheads 100 may form one group so that positions of the printheads can be adjusted, and the plurality of printheads 100 may be set so that at least one printhead 100 to be operated under the control of the control unit 40 is selected and the molten glass is discharged through a nozzle 140 of the selected printhead 100.

The molten glass discharged through the nozzle 140 of the printhead 100 is molded while being sequentially stacked in the workbench 30 disposed below the printhead 100. Operations of the transfer unit 20 and the printhead 100 are independently controlled by the control unit 40. The molding is performed so that the molten glass is manufactured into 3D molded products by adjusting a position of the printhead 100.

The molded product (i.e., a molded body) for artificial teeth manufactured in a 3D shape through the nozzle 140 may be subjected to heat treatment. The molded product for artificial teeth may be crystallized using a heat treatment process. The heat treatment may include first heat treatment for nucleation prior to crystallization, and second heat treatment for crystallization.

Hereinafter, the heat treatment process will be described.

The molded product for artificial teeth is heated to increase the temperature of the molded product to a first temperature (for example, 460 to 540° C.), and the first temperature is maintained for a predetermined time (for example, 10 minutes to 12 hours) to form nuclei for crystallization (a first heat treatment process). The first heat treatment process is preferably performed in an oxidizing atmosphere such as oxygen (O₂), air, etc.

The molded product for artificial teeth is heated to increase the temperature of the molded product to a second temperature (for example, 850 to 930° C.), which is higher than the first temperature, and the second temperature is maintained for a predetermined time (for example, 10 minutes to 24 hours) to crystallize the molded product (a second heat treatment process). The second heat treatment process is preferably performed in an oxidizing atmosphere such as oxygen (O₂), air, etc.

A cooling process of slowly cooling the heat-treated product is performed. The reasons for slow cooling are to remove residual stress and to secure a stable position of an atomic structure during the cooling process.

Artificial teeth including lithium disilicate (Li₂Si₂O₅) as a main crystal phase may be obtained using such a process.

When the 3D printer according to one preferred embodiment of the present invention is used, artificial teeth having excellent thermal durability, chemical durability and oxidation resistance and superior texture may be manufactured.

Hereinafter, the method for manufacturing a machinable glass ceramic molded product using the 3D printer according to one preferred embodiment of the present invention will be described in further detail.

The glass wire that is a raw material is installed in the raw material supply unit 10. The glass wire may be made of glass including 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F). The glass wire may be made of an achromatic transparent glass material, and may also be made of a glass material having a chromatic color.

The glass wire may further include 0.005 to 0.5% by weight of CoO, and the glass wire may be a glass wire having a blue color. The CoO serves as a coloring agent that develops a blue color.

Also, the glass wire may further include 0.005 to 1.0% by weight of Cr₂O₃, and the glass wire may be a glass wire having a green color. The Cr₂O₃ serves as a coloring agent that develops a green color.

In addition, the glass wire may further include 0.05 to 1.0% by weight of MnO₂, and the glass wire may be a glass wire having a purple color. The MnO₂ serves as a coloring agent that develops a purple color.

The glass wire is supplied from the raw material supply unit 10 to the printhead 100 using the transfer unit 20.

The glass wire supplied into the printhead 100 is melted, and the molten glass is discharged through the nozzle 140. The discharge temperature of the molten glass discharged through the nozzle 140 is preferably in a range of approximately 1,000 to 1,600° C. The molten glass discharged through the nozzle 140 preferably has a viscosity ranging from 10² to 10¹⁰ poises.

A plurality of raw material supply units 10 may be provided, the transfer unit 20 may include a plurality of transfer rolls, a plurality of printheads 100 are provided, depending on the number of pairs of transfer rolls and the number of raw material supply units 10, the plurality of printheads 100 may form one group so that positions of the printheads can be adjusted, and the plurality of printheads 100 may be set so that at least one printhead 100 to be operated under the control of the control unit 40 is selected and the molten glass is discharged through a nozzle 140 of the selected printhead 100.

The molten glass discharged through the nozzle 140 of the printhead 100 is molded while being sequentially stacked in the workbench 30 disposed below the printhead 100. Operations of the transfer unit 20 and the printhead 100 are independently controlled by the control unit 40. The molding is performed so that the molten glass is manufactured into 3D molded products by adjusting a position of the printhead 100.

The molded product (i.e., a molded body) manufactured in a 3D shape through the nozzle 140 may be subjected to heat treatment. The molded product may be crystallized using a heat treatment process. The heat treatment may include first heat treatment for nucleation prior to crystallization, and second heat treatment for crystallization.

Hereinafter, the heat treatment process will be described.

The molded product is heated to increase the temperature of the molded product to a first temperature (for example, 500 to 750° C.), and the first temperature is maintained for a predetermined time (for example, 10 minutes to 12 hours) to form nuclei for crystallization (a first heat treatment process). The first heat treatment process is preferably performed in an oxidizing atmosphere such as oxygen (O₂), air, etc.

The molded product is heated to increase the temperature of the molded product to a second temperature (for example, 900 to 1,100° C.), which is higher than the first temperature, and the second temperature is maintained for a predetermined time (for example, 10 minutes to 24 hours) to crystallize the molded product (a second heat treatment process). The second heat treatment process is preferably performed in an oxidizing atmosphere such as oxygen (O₂), air, etc.

A cooling process of slowly cooling the heat-treated product is performed. The reasons for slow cooling are to remove residual stress and to secure a stable position of an atomic structure during the cooling process.

When the 3D printer according to one preferred embodiment of the present invention is used, machinable glass ceramic molded products having excellent mechanical properties, thermal durability, chemical durability and oxidation resistance and superior texture may be manufactured.

The machinable glass ceramic molded products may be manufactured by determining the size and shape of the molded products according to an original equipment manufacturing method. The machinable glass ceramic molded products manufactured thus have an advantage in that the molded products may be machine-shaped according to customer demand.

While the present invention has been shown and described in detail with reference to certain preferred embodiments thereof, it will be understood by those skilled in the art that various changes in form and details may be made therein without departing from the spirit and scope of the invention as defined by the appended claims.

### INDUSTRIAL APPLICABILITY

According to the present invention, the molded products, the artificial teeth, and the machinable glass ceramic molded products, which have excellent mechanical properties, thermal durability, chemical durability and oxidation resistance and superior texture, can be manufactured using the glass wire as the raw material, and thus can be industrially applicable.

1. A 3D printer printhead comprising:
an inlet thorough which a glass wire, which is a raw material, is introduced;
a heating means configured to heat the glass wire introduced through the inlet;
a melting furnace configured to provide a space in which the glass wire is melted to produce a molten glass; and
a nozzle coupled to a lower part of the melting furnace to temporarily store the molten glass or discharge a desired amount of the molten glass,
wherein the melting furnace comprises an outer frame made of a heat-resistant material and an inner frame having a crucible shape, and
the inner frame has a low surface contact angle and is made of platinum (Pt), a Pt alloy and/or graphite, or the inner frame is made of a material having a surface coated with Pt or diamond-like carbon (DLC) so as to prevent the molten glass from sticking thereto.

2. The 3D printer printhead of claim 1, wherein the nozzle comprises an outer frame made of a heat-resistant material and an inner frame has a funnel shape.

3. The 3D printer printhead of claim 1, wherein the outer frames of the melting furnace and the nozzle are made of a refractory material, a ceramic fiber board or a ceramic blanket as a ceramic material for heat insulation.

4. The 3D printer printhead of claim 1, wherein the molten glass discharged through the nozzle has a viscosity ranging from 10² to 10¹⁰ poises.

5. The 3D printer printhead of claim 1, wherein the heating means comprises:
a first heating means provided at a circumference of the melting furnace to melt glass wire inside the melting furnace; and
a second heating means provided at a circumference of the nozzle to regulate the temperature and viscosity of the molten glass to be discharged.

6. The 3D printer printhead of claim 1, wherein a tube configured to guide an influx of the glass wire is coupled to the inlet.

7. The 3D printer printhead of claim 1, wherein the glass wire is made of a glass material having a chromatic color.

8. A 3D printer comprising:
a raw material supply unit configured to supply a glass wire which is a raw material;
a transfer unit configured to transfer the glass wire supplied from the raw material supply unit;
a printhead configured to melt the glass wire transferred by the transfer unit and discharge the molten glass through a nozzle;
a workbench configured to provide a space in which the molten glass discharged through the nozzle of the printhead is molded into a desired shape while being sequentially stacked; and
a control unit configured to independently control operations of the transfer unit and the printhead,
wherein the printhead is disposed above the workbench, and
a molded product having a desired shape is three-dimensionally manufactured by adjusting a position of the printhead.

9. The 3D printer of claim 8, wherein a plurality of raw material supply units are provided,
the transfer unit comprises a plurality of transfer rolls,
a plurality of printheads are provided, depending on the number of pairs of transfer rolls and the number of raw material supply units,
the plurality of printheads form one group so that positions of the printheads are adjusted, and
the plurality of printheads are set so that at least one printhead to be operated under the control of the control unit is selected and the molten glass is discharged through a nozzle of the selected printhead.

10. The 3D printer of claim 8, wherein the glass wire is made of Li₂O—Al₂O₃—SiO₃-based glass or Li₂O—MgO—Al₂O₃—SiO₃-based glass,
the Li₂O—Al₂O₃—SiO₃-based glass is glass comprising 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂, and
the Li₂O—MgO—Al₂O₃—SiO₃-based glass is glass comprising 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

11. The 3D printer of claim 10, wherein the Li₂O—Al₂O₃—SiO₃-based glass or the Li₂O—MgO—Al₂O₃—SiO₃-based glass further comprises 0.005 to 0.5% by weight of CoO, and
the glass wire has a blue color.

12. The 3D printer of claim 10, wherein the Li₂O—Al₂O₃—SiO₃-based glass or the Li₂O—MgO—Al₂O₃—SiO₃-based glass further comprises 0.005 to 1.0% by weight of Cr₂O₃, and
the glass wire has a green color.

13. The 3D printer of claim 10, wherein the Li₂O—Al₂O₃—SiO₃-based glass or the Li₂O—MgO—Al₂O₃—SiO₃-based glass further comprises 0.05 to 1.0% by weight of MnO₂, and
the glass wire has a purple color.

14. The 3D printer of claim 8, wherein the glass wire is made of lithium disilicate-based glass comprising 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO.

15. The 3D printer of claim 8, wherein the glass wire is made of glass comprising 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F).

16. The 3D printer of claim 15, wherein the glass wire further comprises 5.0 to 10.0% by weight of ZrO₂.

17. The 3D printer of claim 15, wherein the glass wire further comprises 0.005 to 0.5% by weight of CoO, and
the glass wire has a blue color.

18. The 3D printer of claim 15, wherein the glass wire further comprises 0.005 to 1.0% by weight of Cr₂O₃, and
the glass wire has a green color.

19. The 3D printer of claim 15, wherein the glass wire further comprises 0.05 to 1.0% by weight of MnO₂, and
the glass wire has a purple color.

20. A method for manufacturing a molded product using the 3D printer defined in claim 8, comprising:
installing a glass wire, which is a raw material, in a raw material supply unit;
supplying the glass wire from the raw material supply unit to a printhead using a transfer unit;
melting the glass wire supplied into the printhead and discharging the molten glass through a nozzle;
molding the molten glass discharged through the nozzle of the printhead while sequentially stacking the molten glass in a workbench disposed below the printhead; and
subjecting the molded product to heat treatment,
wherein operations of the transfer unit and the printhead are independently controlled by a control unit,
the molding is performed so that the molten glass is manufactured into 3D molded products by adjusting a position of the printhead,
the glass wire is made of Li₂O—Al₂O₃—SiO₃-based glass or Li₂O—MgO—Al₂O₃—SiO₃-based glass,
the Li₂O—Al₂O₃—SiO₃-based glass is glass comprising 5.0 to 10.0% by weight of Li₂O, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂, and
the Li₂O—MgO—Al₂O₃—SiO₃-based glass is glass comprising 2.0 to 5.0% by weight of Li₂O, 3.0 to 5.0% by weight of MgO, 15.0 to 20.0% by weight of Al₂O₃, 60.0 to 65.0% by weight of SiO₂, 1.0 to 3.0% by weight of ZnO, 1.0 to 5.0% by weight of SnO₂, and 1.0 to 10.0% by weight of one or more oxides selected from TiO₂ and ZrO₂.

21. The method of claim 20, wherein the heat treatment comprises first heat treatment performed at a temperature of 650 to 800° C. for the purpose of nucleation for crystallization, and second heat treatment performed at a temperature of 900 to 1,100° C. for the purpose of crystallization.

22. The method of claim 20, wherein a plurality of raw material supply units are provided,
the transfer unit comprises a plurality of transfer rolls,
a plurality of printheads are provided, depending on the number of pairs of transfer rolls and the number of raw material supply units,
the plurality of printheads form one group so that positions of the printheads are adjusted, and
the plurality of printheads are set so that at least one printhead to be operated under the control of the control unit is selected and the molten glass is discharged through a nozzle of the selected printhead.

23. A method for manufacturing an artificial tooth using the 3D printer defined in claim 8, comprising:
installing a glass wire, which is a raw material, in a raw material supply unit;
supplying the glass wire from the raw material supply unit to a printhead using a transfer unit;
melting the glass wire supplied into the printhead and discharging the molten glass through a nozzle;
molding the molten glass discharged through the nozzle of the printhead while sequentially stacking the molten glass in a workbench disposed below the printhead; and
subjecting the molded product to heat treatment,
wherein operations of the transfer unit and the printhead are independently controlled by a control unit,
the molding is performed so that the molten glass is manufactured into 3D molded products for artificial teeth by adjusting a position of the printhead, and
the glass wire is made of lithium disilicate-based glass comprising 25.0 to 30.0 mol % Li₂O, 60.0 to 70.0 mol % SiO₂, 0.5 to 1.5 mol % P₂O₅, 1.0 to 6.0 mol % K₂O, and 1.0 to 4.0 mol % ZnO.

24. The method of claim 23, wherein the heat treatment comprises first heat treatment performed at a temperature of 460 to 540° C. for the purpose of nucleation for crystallization, and second heat treatment performed at a temperature of 850 to 930° C. for the purpose of crystallization.

25. The method of claim 23, wherein a plurality of raw material supply units are provided,
the transfer unit comprises a plurality of transfer rolls,
a plurality of printheads are provided, depending on the number of pairs of transfer rolls and the number of raw material supply units,
the plurality of printheads form one group so that positions of the printheads are adjusted, and
the plurality of printheads are set so that at least one printhead to be operated under the control of the control unit is selected and the molten glass is discharged through a nozzle of the selected printhead.

26. A method for manufacturing a machinable glass ceramic molded product using the 3D printer defined in claim 8, comprising:
installing a glass wire, which is a raw material, in a raw material supply unit;
supplying the glass wire from the raw material supply unit to a printhead using a transfer unit;
melting the glass wire supplied into the printhead and discharging the molten glass through a nozzle;
molding the molten glass discharged through the nozzle of the printhead while sequentially stacking the molten glass in a workbench disposed below the printhead; and
subjecting the molded product to heat treatment,
wherein operations of the transfer unit and the printhead are independently controlled by a control unit,
the molding is performed so that the molten glass is manufactured into 3D molded products by adjusting a position of the printhead, and
the glass wire is made of glass comprising 10.0 to 15.0% by weight of MgO, 5.0 to 20.0% by weight of Al₂O₃, 45.0 to 55.0% by weight of SiO₂, 5.0 to 10.0% by weight of K₂O, and 5.0 to 10.0% by weight of fluorine (F).

27. The method of claim 26, wherein the heat treatment comprises first heat treatment performed at a temperature of 500 to 750° C. for the purpose of nucleation for crystallization, and second heat treatment performed at a temperature of 900 to 1,100° C. for the purpose of crystallization.

28. The method of claim 26, wherein a plurality of raw material supply units are provided,
the transfer unit comprises a plurality of transfer rolls,
a plurality of printheads are provided, depending on the number of pairs of transfer rolls and the number of raw material supply units,
the plurality of printheads form one group so that positions of the printheads are adjusted, and
the plurality of printheads are set so that at least one printhead to be operated under the control of the control unit is selected and the molten glass is discharged through a nozzle of the selected printhead.
